(19) United States
(12) Patent Application Publication
(10) Pub. No.: US 2025/0179238 A1
(43) Pub. Date: Jun. 5, 2025

(54) Sub-Conductor Insulation and Sub-Conductor Composite of an Electric Rotating Machine

(71) Applicant: Siemens Aktiengesellschaft, München (DE)

(72) Inventors: Steffen Lang, Hallerndorf (DE); Niels Müller, Georgensgmünd (DE)

(73) Assignee: Siemens Aktiengesellschaft, München (DE)

(21) Appl. No.: 18/845,076

(22) PCT Filed: Mar. 8, 2023
(86) PCT No.: PCT/EP2023/055831

§ 371 Date: Sep. 9, 2024

(30) Foreign Application Priority Data
Mar. 8, 2022 (DE) 10 2022 202 324.2

(51) Int. Cl. C08G 59/22; C08G 59/24; C08G 59/30; C08G 59/42; C08G 59/68; C08J 5/24; H02K 3/30

(52) U.S. Cl. CPC C08G 59/226; C08G 59/245; C08G 59/306; C08G 59/4215; C08G 59/686; C08J 5/24; H02K 3/30; C08J 2363/02

(57) ABSTRACT

Various teachings of the present disclosure include a sub-conductor insulation with a prepreg including a solid insulation material in a prepreg matrix. The prepreg matrix includes solid insulation material in the form of layers, laminate layers, tapes, as paper and/or in the form of bound barrier material particles. The solid insulation material comprises at least partial discharge-resistant material. The prepreg matrix includes carbon compounds and up to 45 wt % of the total weight of the prepreg matrix of one or more silicon-containing components. The solid insulation material is embedded in the prepreg matrix and is wound in a precured B-stage as sub-conductor insulation.

### CROSS-REFERENCE TO RELATED APPLICATIONS

This application is a U.S. National Stage Application of International Application No. PCT/EP2023/055831 filed Mar. 8, 2023, which designates the United States of America, and claims priority to DE Application No. 10 2022 202 324.2 filed Mar. 8, 2022, the contents of which are hereby incorporated by reference in their entirety.

### TECHNICAL FIELD

The present disclosure relates to insulation. Various embodiments of the teachings herein include a sub-conductor insulation which can be produced by machine processing of a corresponding prepreg in automated processes during the production of sub-conductor insulations of electrical rotating machines.

### BACKGROUND

In electrical machines, an electrical conductor is generally split into a plurality of parallel sub-conductors. This pertains both to electrical rotating machines with a high rated voltage, in which the sub-conductors are often in the form of flat wires and to electrical rotating machines with a low rated voltage, for example traction motors, in which the sub-conductors are in the form of round wires. Sub-conductors are layered or arranged over one another in the groove with a different potential. So that these sub-conductors are not electrically short-circuited with one another, they need to be electrically insulated from one another by a sub-conductor insulation. The grooves of the lamination stack of the cylindrically constructed rotor of an electrical rotor machine such as a motor, for example a traction motor, are then filled with the arrangement and/or layering-also referred to as a sub-conductor composite. During the introduction of the sub-conductors and/or of the sub-conductor composite, it is important for the insulation of the sub-conductors to be preserved. Particularly at the edges in the case of flat wires, mechanical damage may occur during the introduction of the sub-conductor composite into the groove.

The winding of an electrical rotating machine comprises sub-conductor composites, in particular composites consisting of flat wire sub-conductors in the form of coils, for example three, which themselves have a plurality of turns that are formed by sub-conductors. Sub-conductors are then layered over one another with a different potential in a groove in the lamination stack. So that these sub-conductors are not electrically short-circuited with one another, they need to be electrically insulated from one another with a sub-conductor insulation. Depending on the design of the windings, layered sub-conductor composites may also be arranged next to one another in the groove. The insulated and layered sub-conductors, which are for example arranged parallel, then form the sub-conductor composite. During the winding and introduction into the grooves, abrasion or other damage of the sub-conductor insulation often takes place, particularly at the edges.

The sub-conductor edges are precisely the region with the highest electrical field strength due to the geometrical field increase at the edge. The risk of igniting partial discharges during operation is the greatest there. In the course of the operating time, these partial discharges may damage the polymeric insulation in such a way that sub-conductor insulation breaks down and two electrical sub-conductors are short-circuited with one another.

After the individual sub-conductors have been introduced into the groove, although the individual sub-conductors are electrically insulated from one another and fixed with respect to one another, the sub-conductor composite is also provided with a main insulation in order to be insulated sufficiently well by the latter from the grounded lamination stack. The greatest voltage difference is then to be encountered not between the sub-conductors but between the sub-conductor with the highest voltage and the lamination stack, of which the groove is a part.

This is achieved by a main insulation, which additionally insulates the sub-conductor insulation and the layered sub-conductor composite from the lamination stack. In some cases, a VPI process is used. If there are defects on the individual sub-conductor insulation or on the sub-conductor composite, this weak point propagates through the entire insulation with disastrous consequences for the service life of the electrical rotating machine. The technique of producing a sub-conductor composite and/or the individual sub-conductor insulation is therefore an important factor for the quality of the electrical rotating machine.

This is all the more so because the partial discharges that occur lead to very strong local heating by which the organic, carbon-containing constituents of the insulation system are very greatly degraded and are converted into the gaseous phase, “CO₂ release”. By the progressive partial discharge stress, the insulation system becomes damaged until the breakdown strength is exceeded and an electrical short circuit takes place between a sub-conductor and the lamination stack, and the machine therefore fails. The problem of electrical erosion by partial discharge stress is being exacerbated by continuing development of electrical rotating machines that aim to increase the power density. Greater emphasis is therefore being placed on the partial discharge resistance of sub-conductors.

### SUMMARY

Teachings of the present disclosure include techniques for sub-conductor insulation which increases the partial discharge resistance, in particular the partial discharge resistance at the edges and radii of the sub-conductors, both mechanically against impairment or damage of the sub-conductor insulation when the sub-conductor composites are being introduced or laid into the grooves since the edges are the most vulnerable part of the sub-conductor composite during introduction into the—likewise edged—groove, and dielectrically and in terms of material technology by virtue of the composition and structure of the sub-conductor insulation against partial discharges that occur during operation, particularly at the edges since the region of a geometrical field increase exists there.

For example, some embodiments of the teachings herein include a sub-conductor insulation consisting of a prepreg that comprises a solid insulation material in a prepreg matrix, wherein the prepreg matrix contains solid insulation material in the form of layers, laminate layers, tapes, as paper and/or in the form of bound barrier material particles, and the solid insulation material comprises at least partial discharge-resistant material, optionally with a tape adhesive, wherein the prepreg matrix is based on carbon compounds but up to 45 wt %, up to 35 wt % and up to 25 wt % of the total weight of the prepreg matrix is replaced with one or more silicon-containing component(s), wherein the solid insulation material is embedded in the prepreg matrix and is processed, in particular wound, in the precured B stage as sub-conductor insulation and/or to form the sub-conductor composite.

In some embodiments, the one or more silicon-containing component(s) is or are selected from the following group: siloxane, polysiloxane, silsesquioxane and/or polysilsesquioxane and any combinations, blends, copolymers and/or mixtures of the aforementioned silicon-containing compounds.

In some embodiments, the prepreg matrix comprises at least one silicon-containing component that comprises at least 2 and preferably between 8 and 12 saturated and/or unsaturated epoxycycloalkyl groups.

In some embodiments, at least one epoxycycloalkyl group in the prepreg matrix is selected from a group which comprises epoxy-C3-C8-cycloalkyl groups, and/or wherein at least one epoxycycloalkyl group is bonded via a spacer to a structural element of a silicon-containing component.

In some embodiments, a silicon-containing component in the prepreg matrix comprises at least one epoxycycloalkyl group-containing polysilsesquioxane.

In some embodiments, the at least one epoxycycloalkyl group-containing polysilsesquioxane in the prepreg matrix has a random structure, a conductor structure or a cage structure.

In some embodiments, a silicon-containing component comprises a cycloaliphatic epoxy resin, in particular 3,4-epoxycyclohexylmethyl-3′,4′-epoxycyclohexane carboxylate.

In some embodiments, the prepreg matrix comprises at least one polysiloxane, in particular a diglycidyl ether-terminated poly(dialkyl siloxane) and/or a diglycidyl ether-terminated poly(phenyl siloxane).

In some embodiments, the carbon-containing base resin in the prepreg matrix is selected from a group which comprises anhydride derivative-containing epoxy resins and anhydride derivative-free epoxy resins, in particular an epoxy resin selected from the group of the following compounds: bisphenol A diglycidyl ether (BADGE), bisphenol F diglycidyl ether (BFDGE), epoxy novolak, epoxy phenol novolak, polyurethanes, polyester, polyamide, polyamide-imide, polyetherimide and/or any mixture and/or copolymer of these carbon-based resins.

In some embodiments, the prepreg matrix contains a curing agent selected from a group which comprises cationic and anionic curing catalysts, amines, acid anhydrides, in particular methylhexahydrophthalic anhydride, siloxane-based curing agents, oxirane group-containing curing agents, in particular glycidyl ethers, superacids, epoxy-functionalized curing agents or any mixture thereof, and/or in that the prepreg matrix comprises at least one accelerator substance, in particular a tertiary amine and/or an inorganic zinc salt.

In some embodiments, the prepreg matrix contains a carbon-containing base resin in an amount of 10 wts or more.

In some embodiments, the prepreg matrix contains a silicon-containing component in an amount of 5 wt % or more.

As another some embodiments include a sub-conductor insulation for electrical conductors of an electrical rotating machine in flat wire form, which can be produced by winding a prepreg as described herein around the electrically conductive flat wires.

In some embodiments, the sub-conductor insulation can be produced by winding prepreg in the form of layers as described herein around the sub-conductor.

As another example, some embodiments include a sub-conductor composite, which can be obtained by winding from insulated sub-conductors with a prepreg as described herein in the form of tape layers.

As another example, some embodiments include an electrical rotating machine comprising a sub-conductor insulation comprising a sub-conductor insulation as described herein.

### DETAILED DESCRIPTION

Accordingly, the teachings of the present disclosure include a sub-conductor insulation consisting of a prepreg that comprises a solid insulation material in a prepreg matrix, wherein
the prepreg matrix contains solid insulation material in the form of layers, laminate layers, tapes, as paper and/or in the form of bound barrier material particles, and the solid insulation material comprises at least partial discharge-resistant material, optionally with a tape adhesive, wherein
the prepreg matrix is based on carbon compounds but up to 45 wt %, up to 35 wt %, or up to 25 wt % of the total weight of the prepreg matrix is replaced with one or more silicon-containing component(s), wherein
the solid insulation material is embedded in the prepreg matrix and can be processed in the precured B stage.

A “prepreg matrix” means a carbon-containing—at least partially substituted with silicon-containing resin—synthetic resin or thermoset material, for example epoxide, polyester, polyamide, polyamide-imide, polyetherimide and/or any mixture and/or copolymer of these carbon-based compounds, in particular resins, which after curing provide a plastic, i.e. in the fully cured state a thermoset material.

In some embodiments, the one or more silicon-containing component(s) is or are selected from the following group: siloxane, polysiloxane, silsesquioxane and/or polysilsesquioxane and any combinations, blends, copolymers and/or mixtures of the aforementioned silicon-containing compounds.

In some embodiments, the prepreg is processed by winding, a prepreg being wound around a conduction element, for example a copper round wire, to form the insulation. This creates the so-called sub-conductor insulations. Winding around a stack of insulated sub-conductors creates a sub-conductor composite.

Typically, thermoset materials cannot be melted without decomposition but decompose before softening. This is attributable to the three-dimensional crosslinking of the monomer units that form the thermoset material by curing. Before this full curing “C stage”, the monomer units are in a “B stage” in which there is crosslinking, so that the monomers are no longer flowable, but this is crosslinking that can be melted without decomposition, i.e. “liquefiable” crosslinking. For example, there is linear chain crosslinking but not yet transverse crosslinking. This pre-crosslinking is the B stage of the prepreg matrix during processing. Pure epoxy resins can be pre-crosslinked well but are highly fluid and therefore flow away—especially at the edges—with slight heating. The prepregs described herein in the B stage are in an incompletely cured, flexible state which prevents flow away from the edges.

By addition of sterically complex polysiloxanes and/or silsesquioxanes, the B stage of the prepreg matrix has a very different rheology than that based exclusively on carbon since these—for example sterically complex—silicon-based monomer units in the B stage already provide a high strength of the synthetic resin while maintaining the full flexibility of the B stage. They are therefore both more readily processable and mechanically more stable, and above all suitable for keeping the resin in the B stage for longer, for example at the edges, than is the case with pure carbon-based synthetic resins.

In some embodiments, the prepreg is applied in the form of flat material, for instance layers, in particular tape-like layers, also referred to as “tape layers”, onto the sub-conductors. For example, the prepreg is wound in the form of at least two layers around the sub-conductors.

A barrier material, in particular mica or containing mica, is incorporated as a partial discharge-resistant material into the prepreg. The barrier material may be introduced into the matrix while bound to a carrier, for instance a woven fabric. In some embodiments, the barrier material is—not necessarily—bound to the carrier by additional adhesive. This bound barrier material, for example mica paper, and/or the combination of a carrier and the barrier material, then forms the so-called solid insulation material, for example a wrapping tape for a wrapping tape insulation. The solid insulation material is in the form of tapes and/or in layers—for example in the form of laminate layers—and is impregnated with the formulation, which after precuring forms a prepreg matrix according to the invention, in order to produce the prepreg and is brought into the B stage by precuring.

This product, i.e. the solid insulation material embedded in the matrix of carbon-based synthetic resin in which up to 45 wt % of the carbon bonds are replaced with silicon bonds, this precursor then being partially cured as far as the B stage of the matrix, corresponds to the prepreg. The prepreg is wound as insulation, for example as sub-conductor insulation, around for example a copper flat wire, a coil in hairpin technology and/or a similar conductor element of an electric motor. The so-called sub-conductor insulation is created by winding the prepreg—for example—in the form of bindings around the conduction element, for instance a flat wire.

A composite consisting of a stack of such insulated sub-conductors is referred to as a sub-conductor composite and is itself formed by winding the prepreg around the stack, for example as a laminate which may be formed for example from a laminate layer stack out of which tapes are cut. The prepreg matrix is generally sufficient for the prepreg to contain the mica chemically and physically stably in respect of storage and homogeneously distributed, although a tape adhesive may optionally also be provided.

When applying the prepreg in the form of tape layers, the tape layers may be wound continuously and/or in the same direction around the sub-conductor or sub-conductors. Here, the second tape layer may be wound offset by from 40% to 60% over the first tape layer around the sub-conductor or sub-conductors.

Monomer units for epoxy resins, which carry epoxide groups on a carbon skeleton, may be produced by reacting a compound having hydroxyl groups and/or amines and/or amides and epichlorohydrin. Suitable compounds having hydroxyl groups are for example aliphatic diols, phenols, phenolic compounds and/or dicarboxylic acids. As phenols, compounds such as bisphenol A, bisphenol F and/or novolaks are used. As polyvalent alcohols, compounds such 1,4-budanediol are employed. Diols and polyols lead to diglycidyl polyethers.

The prepreg matrix also comprises a mixture of resin and curing agent in the stoichiometric ratio in the case of addition polymerization, and in the case of homopolymerization with a small proportion of initiator—for example less than 10 wt %—less than 5 wt %, less than 2 wt %, or within a range of from 0.5 to 1.5 wt %, expressed in terms of the total mass of the prepreg matrix in question.

B stage or B state refers to a state of the precuring of the synthetic resin in which the prepreg matrix is still in solid form, and can therefore be processed as sub-conductor insulation, but can still be melted without decomposition. The prepreg is processed in the B stage and then with the formation of the main insulation—for example under pressure and heat—cured by hot pressing to form the fully cured sub-conductor insulation and/or the fully cured sub-conductor composite.

In the prepreg matrix, a not insignificant part of the carbon-based resin fraction of the prepreg matrix is substituted with monomer units that carry epoxide groups on a silicon-containing component. A “silicon-containing component” refers for example to compound classes such as siloxane, polysiloxane, silsesquioxane and/or polysilsesquioxane.

The prepreg matrix contains the silicon-containing component in a proportion greater than/equal to 2 wt %, i.e. for example 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%. It is to be understood that the substance proportions of all compounds of the resin formulation always add up to 100 wt %.

The prepreg matrix contains the carbon-based resin fraction in a proportion greater than/equal to 8 wt %, i.e. for example 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98% or 99%.

In some embodiments, in addition to the carbon-based basic resin, the prepreg matrix comprises at least one silicon-containing component having at least one saturated and/or unsaturated epoxycycloalkyl group, by means of which a glass transition temperature of the insulation material is increased in comparison with an impregnation formulation without the silicon-containing component. In other words, the prepreg matrix contains at least two constituents, namely a carbon-containing basic resin and a silicon-containing component that preferably has one or more epoxycycloalkyl groups, in which case each of the epoxycycloalkyl groups may be saturated or singly or multiply unsaturated.

Unsaturated epoxycycloalkyl groups may also be referred to as epoxycycloalkenyl groups. The cycloaliphatic epoxide functionality or functionalities of the silicon-containing component is or are sterically very encumbering and has or have a high spatial requirement due to the nonplanar cycloaliphatic ring structure. The incorporation of this structure or these structures into the polymer network of the cured insulation material, in comparison with a matrix that does not contain the at least one silicon-containing containing component but in other regards has the same composition, therefore leads to higher glass transition temperatures together with an increased electrical stability of the cured insulation material.

The glass transition generally takes place not at a sharp temperature value but in a glass transition temperature range. In such a case, the average temperature value of the glass transition temperature range is used as the glass transition temperature. The molar stoichiometric ratio of resin formulation to curing agent—in the case of addition polymerization—may be adjusted according to requirements, normally with a ratio in the range of from about 1:0.9 to about 1:1.1 being used.

In some embodiments, a silicon-containing component comprises at least 2 or between 8 and 12 saturated and/or unsaturated epoxycycloalkyl groups. In other words, a silicon-containing component has a plurality of saturated and/or unsaturated epoxycycloalkyl groups, namely for example 2, 3, 4, 5, 6, 7, 8, 9, 10, 11, 12 or more. In this way, the silicon-containing component may be used as a multifunctional crosslinking agent having an adjustable spatial requirement so that the glass transition temperature of the cured insulation material can be adjusted especially precisely.

In some embodiments, at least one epoxycycloalkyl group is bonded via a spacer to a structural element of a silicon-containing component. The spacer may for example be a C₁-C₁₂ alkyl radical and generally be bonded to any suitable position of the cycloalkyl group. This likewise enables especially precise adjustment of the glass transition temperature and in a particular case facilitates the arrangement of a plurality of epoxycycloalkyl groups on the structural element of a silicon-containing component contained in the prepreg matrix.

In some embodiments, at least one of the epoxycycloalkyl groups contained is selected from a group which comprises epoxy-C3-C8-cycloalkyl groups. In other words, at least one epoxycycloalkyl group may be epoxycyclopropyl, epoxycyclobutyl, an epoxycyclopentyl, epoxycyclohexyl, epoxycycloheptyl or epoxycyclooctyl group. In this way as well, the spatial requirement of the silicon-containing component and therefore the glass transition temperature of the cured prepreg and/or insulation material may be adjusted especially precisely.

In some embodiments, the prepreg matrix comprises at least one epoxycycloalkyl group-containing polysilsesquioxane. Polysilsesquioxanes are silicon resins which can be synthesized by using trifunctional organosilane compounds and constitute an organic-inorganic hybrid material that combines the inorganic properties of the siloxane bond (Si—O—Si), which is formed by the main chain, and the organic properties of the organic functional group which is formed by the side chain or chains. This molecular, at room temperature “liquid sand”, which normally has particle diameters≤1 nm, may generally be modified with one or more epoxycycloalkyl functionalities, in which case each epoxycycloalkyl group may be bonded via a spacer, for instance a methyl, ethyl, propyl group, etc., to a silicon atom as a structural element of the polysilsesquioxane.

In this way, such polysilsesquioxane derivatives on the one hand have a good solubility in epoxy resins, and on the other hand their UV stability and hydrophobicity may be increased. In this case, parts of the carbon-based diglycidyl ether are replaced for example with glycidyl ether-functionalized polyhedral silsesquioxanes.

The cycloaliphatic epoxy functionality or functionalities of these hybrid molecules can, for example, copolymerize with an anhydride-containing basic epoxy resin and are thus fully and highly dispersedly incorporated in the resulting prepreg matrix. The cycloaliphatic epoxy functionality or functionalities has or have the aforementioned high stericity due to the nonaromatic ring structure(s) and lead to higher glass transition temperatures when the silicon-containing component is incorporated into the polymer network. Since the backbone of these polysilsesquioxane derivatives used as additives consists of a (poly)oligosiloxane—i.e. organically modified silicon—which for example according to the formula (epoxycyclohexylethyl)₈-₁₂ (SiO_{1.5})₈-₁₂ is already oxidized 1.5 times—the stage with the fully oxidized and quasi-organically embedded silicon dioxide is reached very rapidly by partial discharge bombardment during the operation of an associated electrical machine, so that these polysilsesquioxane derivatives in the prepreg matrix are converted under electrical stress in-situ into a highly active anti-erosion additive.

The aforementioned polysilsesquioxane derivatives also have further properties such as transparency, heat resistance, hardness, electrical resistivity, dimensional stability (low thermal expansion) and flame retardancy. Besides one or more cycloaliphatic epoxy functionalities, one or more different functional groups may in principle be provided, by means of which further properties such as compatibility with the epoxy basic resin and/or the curing agent formulation, dispersion stability, storage stability, breaking factor and reactivity may be adjusted.

Further advantages may be obtained by the at least one epoxycycloalkyl group-containing polysilsesquioxane having a random structure, a conductor structure and/or a cage structure. In this way, the resulting glass transition temperature of the prepreg matrix for the sub-conductor insulation may be purposely influenced. For example, the epoxycycloalkyl group-containing polysilsesquioxane may have a cage structure with 6, 8, 10 or 12 Si vertices.

In some embodiments, the prepreg comprises or is a matrix in particular 3,4-cycloaliphatic epoxy resin, epoxycyclohexylmethyl-3′,4′-epoxycyclohexane carboxylate. This also constitutes an advantageous glass transition modifier by means of which the glass transition temperature of the insulation material subsequently cured starting from the prepreg material may advantageously be increased.

Further advantages may be obtained by the prepreg matrix additionally comprising at least one polysiloxane, in particular a diglycidyl ether-terminated poly(dialkyl siloxane) and/or a diglycidyl ether-terminated poly(phenyl siloxane). Like polysilsesquioxanes, polysiloxanes can form an —SiR₂—O backbone in the cured insulation material. Here, “R” stands for all types of organic radicals that are suitable for curing and/or crosslinking to form an insulation material. In particular, R stands for aryl, alkyl, heterocyclics, nitrogen-, oxygen- and/or sulfur-substituted aryls and/or alkyls. In particular, each R may be selected identically or differently and may in general stand for the groups: alkyl, for example methyl, propyl, isopropyl, butyl, isobutyl, tertbutyl, pentyl, isopentyl, cyclopentyl and all further analogs up to dodecyl, i.e. the homolog with 12 C atoms;
aryl, for example: benzyl, benzoyl, biphenyl, toluyl, xylols, etc., in particular for example all aryl radicals whose structure corresponds to the Hückel definition for aromaticity,
heterocyclics: in particular sulfur-containing heterocyclics such as thiophene, tetrahydrothiophene, 1,4-thioxane and homologs and/or derivatives thereof,
oxygen-containing heterocyclics, for example dioxanes,
nitrogen-containing heterocyclics, for example —CN, —CNO, —CNS, —N₃ (azide), etc.
sulfur-substituted aryls and/or alkyls: for example thiophene, as well as thiols.

In some embodiments, the synthetic resin is selected from a group which comprises phthalic anhydride derivative-containing epoxy resins and phthalic anhydride derivative-free epoxy resins, in particular bisphenol A diglycidyl ether (BADGE), bisphenol F diglycidyl ether (BFDGE), epoxy novolak, epoxy phenol novolak, epoxy polyurethanes or any mixture thereof. For example, the epoxy basic resin may be undistilled and/or distilled bisphenol A diglycidyl ether optionally diluted with reactive thinner, undistilled and/or distilled bisphenol F diglycidyl ether optionally diluted with reactive thinner, hydrogenated bisphenol A diglycidyl ether and/or hydrogenated bisphenol F diglycidyl ether, epoxy novolak and/or epoxy phenol novolak in pure form and/or diluted with solvents, cycloaliphatic epoxy resins such as 3,4-epoxycyclohexylmethyl-3,4-epoxycyclohexyl carboxylate, for example CY179, ERL-4221; Celloxide 2021P, bis(3,4-epoxycyclohexylmethyl) adipate, for example ERL-4299; Celloxide 2081, vinylcyclohexene diepoxide, for example ERL-4206; Celloxide 2000, 2-(3,4-epoxycyclohexyl-5,5-spiro-3,4-epoxy)-cyclohexane-meta-dioxane, for example ERL-4234; hexahydrophthalic diglycidyl ester, for example CY184, EPalloy 5200; tetrahydrophthalic diglycidyl ether, for example CY192; glycidated amino resins (N,N-diglycidyl para-glycidyloxyaniline, for example MY0500, MY0510, N,N-diglycidyl-meta-glycidyloxyaniline, for example MY0600, MY0610, N,N,N′, N′-tetraglycidyl-4,4′-methylenedianiline, for example MY720, MY721, MY725, and any mixtures of the aforementioned compounds.

In some embodiments, the curing agents—for the case of addition polymerization—and/or the initiators—for the case of homopolymerization and optionally also for the case of addition polymerization—are selected from a group which comprises cationic and anionic curing catalysts, amines, acid anhydrides, in particular methylhexahydrophthalic anhydride, siloxane-based curing agents, oxirane group-containing curing agents, in particular glycidyl ethers, superacids, epoxy-functionalized curing agents or any mixture thereof, and/or a tertiary amine and/or an inorganic zinc salt. For example, one or more organic salts such as organic ammonium, sulfonium, iodonium, phosphonium and/or imidazolium salts and amines such as tertiary amines, pyrazoles and/or imidazole compounds may be present as an initiator. Examples which may be mentioned here are 4,5-dihydroxymethyl-2-phenylimidazole and/or 2-phenyl-4-methyl-5-hydroxymethylimidazole.

It has been found that organic, in some cases inviscid, glycidyl ether-functionalized methyl/phenyl polysiloxanes and/or silsesquioxanes in anhydride-containing as well as anhydride-free carbon-based synthetic resin mixtures, for example epoxy resins, polyimides, polyamides, . . . , with thermal precuring lead to advantageous prepreg matrices for sub-conductor insulations.

The prepreg matrices produced on the basis of glycidyl ether by using polysiloxane-containing and/or polysilsesquioxane-containing synthetic resins are substantially more suitable than the purely carbon-based prepreg matrices for adhesion of the prepreg to the sub-conductors and in particular to the sub-conductor edges and for the formation of the sub-conductor composite, particularly with a view to introducing the sub-conductor composite into a groove.

As solid insulation material, the coating comprises for example barrier material, in particular consisting of or comprising mica particles, SiO₂ nanoparticles and/or similar partial discharge-resistant particles, including mineral particles.

For example, the following prepreg matrices may be employed in order to achieve the technical effect:

### EXAMPLE 1

40 wt % polysiloxane-substituted epoxy resin component (1,3-bis(3-glycidyl-oxypropyl)tetramethyldisiloxane), 10 wt % cycloaliphatic epoxy resin component (3,4-epoxycyclohexylmethyl-3′,4′-epoxycyclohexane carboxylate), 50 wt % bisphenol A diglycidyl ether as epoxy basic resin;

### EXAMPLE 2

40 wt % polysiloxane-substituted epoxy resin component (1,3-bis(3-glycidyl-oxypropyl) tetramethyldisiloxane), 20 wt % cycloaliphatic epoxy resin component (3,4-epoxycyclohexylmethyl-3′,4′-epoxycyclohexane carboxylate), 40 wt % bisphenol A diglycidyl ether as epoxy basic resin;

### EXAMPLE 3

30 wt % polysiloxane-substituted epoxy resin component (1,3-bis(3-glycidyl-oxypropyl) tetramethyldisiloxane), 30 wt % cycloaliphatic epoxy resin component (3,4-epoxycyclohexylmethyl-3′,4′-epoxycyclohexane carboxylate), 40 wt % bisphenol A diglycidyl ether as epoxy basic resin;

### EXAMPLE 4

20 wt % polysiloxane-substituted epoxy resin component (1,3-bis(3-glycidyl-oxypropyl) tetramethyldisiloxane), 40 wt % cycloaliphatic epoxy resin component (3,4-epoxycyclohexylmethyl-3′,4′-epoxycyclohexane carboxylate), 40 wt % bisphenol A diglycidyl ether as epoxy basic resin.

In all examples, an anhydride, for example a phthalic anhydride, for example methylhexahydrophthalic anhydride, may be used as a curing agent. In all examples, 0.8 wt % benzyldimethylamine, expressed in terms of the total mass of the prepreg matrix in question, may for example be used as an initiator.

By the sub-conductor insulation proposed here for the first time and/or the sub-conductor composite that can be produced by means of prepregs, it is possible to provide sub-conductor insulations which, owing to their good mechanical properties and high partial discharge resistance, counteract the extreme electrical stress at the edges and/or radii of the sub-conductors and therefore lead to an improvement of the entire insulation system at the weak point of the sub-conductor insulation, particularly at the edges and/or radii in the case of the sub-conductor insulation. Inter alia, by means of elemental analysis it is possible at any time to detect whether or not Si atoms have been employed in the sub-conductor insulation.

What is claimed is:

1. A sub-conductor insulation comprising:
a prepreg including a solid insulation material in a prepreg matrix;
wherein the prepreg matrix includes solid insulation material in the form of layers, laminate layers, tapes, as paper and/or in the form of bound barrier material particles, and
the solid insulation material comprises at least partial discharge-resistant material;
the prepreg matrix includes carbon compounds and up to 45 wt % of the total weight of the prepreg matrix of one or more silicon-containing components; and
the solid insulation material is embedded in the prepreg matrix and is wound in a precured B-stage as sub-conductor insulation.

2. The sub-conductor insulation as claimed in claim 1, wherein the one or more silicon-containing components are selected from the group consisting of:
siloxane, polysiloxane, silsesquioxane, and/or polysilsesquioxane.

3. The sub-conductor insulation as claimed in claim 1, wherein the prepreg matrix comprises at least one silicon-containing component that comprises at least 2 saturated and/or unsaturated epoxycycloalkyl groups.

4. The sub-conductor insulation as claimed in claim 1, wherein
at least one epoxycycloalkyl group in the prepreg matrix includes an epoxy-C3-C8-cycloalkyl group, and/or
at least one epoxycycloalkyl group is bonded via a spacer to a structural element of a silicon-containing component.

5. The sub-conductor insulation as claimed in claim 1, wherein the prepreg matrix comprises at least one epoxycycloalkyl group-containing polysilsesquioxane.

6. The sub-conductor insulation as claimed in claim 5, wherein the at least one epoxycycloalkyl group-containing polysilsesquioxane in the prepreg matrix has a random structure, a conductor structure, or a cage structure.

7. The sub-conductor insulation as claimed in claim 1, wherein a silicon-containing component comprises a cycloaliphatic epoxy resin, in particular 3,4-epoxycyclohexylmethyl-3′,4′-epoxycyclohexane carboxylate.

8. The sub-conductor insulation as claimed in claim 1, wherein the prepreg matrix comprises at least one polysiloxane.

9. The sub-conductor insulation as claimed in claim 1, wherein the carbon-containing base resin includes an epoxy resin selected from the group consisting of: bisphenol A diglycidyl ether (BADGE), bisphenol F diglycidyl ether (BFDGE), epoxy novolak, epoxy phenol novolak, polyurethanes, polyester, polyamide, polyamide-imide, and polyetherimide.

10. The sub-conductor insulation as claimed in claim 1, wherein;
the prepreg matrix includes a curing agent selected from a group consisting of: cationic and anionic curing catalysts, amines, acid anhydrides, methylhexahydrophthalic anhydride, siloxane-based curing agents, oxirane group-containing curing agents, glycidyl ethers, superacids, epoxy-functionalized curing agents and/or
the prepreg matrix comprises at least one accelerator substance.

11. The sub-conductor insulation as claimed in claim 1, wherein the prepreg matrix contains a carbon-containing base resin in an amount of 10 wt % or more.

12. The sub-conductor insulation as claimed in claim 1, wherein the prepreg matrix includes a silicon-containing component in an amount of 5 wt % or more.

13-16. (canceled)
